(19) United States
(12) Patent Application Publication
(10) Pub. No.: US 2012/0159712 A1
(43) Pub. Date: Jun. 28, 2012

(54) BED STRUCTURE

(76) Inventor: Chin-Shun Lee, Guanyin Township (TW)

(21) Appl. No.: 12/975,869

(22) Filed: Dec. 22, 2010

(51) Int. Cl. A61G 7/015

(52) U.S. Cl. 5/613

(57) ABSTRACT

A bed structure includes a first body, a second body, a third body, a supporting frame, a first driving assembly and a second driving assembly. The first body extends to form a first arm and a second arm. The distal ends of the first arm and the second arm are provided with a sliding element respectively sliding in a guiding rail of the supporting frame. By this arrangement, the inclination of the bed structure of the present invention can be adjusted smoothly, so that a user lying thereon can feel more comfortable.

### BACKGROUND OF THE INVENTION

1. Field of the Invention

The present invention relates to a bed structure, and in particular to a bed structure, in which the inclination angle thereof can be adjusted smoothly, so that a user lying thereon can feel more comfortable.

2. Description of Prior Art

In order to make a patient lying on a conventional sickbed to sit up or change into a comfortable posture, the conventional sickbed is constituted of a plurality of bed supports. By changing the angles between the respective bed supports, the posture of the patient on the sickbed can be changed.

In the conventional sickbed structure, a telescopic element is pivotally connected between a back support and a buttocks support. A lifting mechanism is connected to the back support and the buttocks support. The lifting mechanism is driven by a power source to activate the back support and the buttocks support. In this way, the angle between the back support and the buttocks support can be changed according to the lying or sitting posture of the patient.

However, the adjustment of the conventional sickbed needs two power sources to control the inclination angle of the back support and the buttocks support respectively, which makes the assembly of the sickbed more complicated and increases the production cost.

Further, in the conventional sickbed, only the inclination angle between the back support and the buttocks support can be changed. Thus, the adjustment of the conventional sickbed is so limited that a posture simulating a no gravity state is impossible. Thus, the patient lying on the conventional sickbed cannot feel very comfortable.

Therefore, according to the above, the conventional sickbed is provided with two power sources, which requires much time and work for assembly.

The conventional sickbed structure has the following problems:

(1) higher production cost; and

(2) uneasy to adjust the inclination angle thereof.

### SUMMARY OF THE INVENTION

In order to solve the above problems, an objective of the present invention is to provide a bed structure in which its inclination angle can be adjusted more smoothly.

In order to achieve the above objective, the present invention is to provide a bed structure, comprising a first body, a second body, a third body, a supporting frame, a first driving assembly and a second driving assembly. The first body has a first fixing support and at least one first plate. Both sides of the first fixing support extend to form a first connecting end, a second connecting end, a first arm and a second arm respectively. The distal ends of the first arm and the second arm are provided with at least one sliding element respectively. The second body has a second fixing support and at least one second plate. One side of the second fixing support extends to form a third connecting end pivotally connected to the first connecting end. The third body has a third fixing support and at least one third plate. One side of the third fixing support extends to form a fourth connecting end pivotally connected to the second connecting end. The supporting frame has a guiding rail. The sliding element is slidingly disposed in the guiding rail. The first driving assembly has a first driving unit and a first connecting rod. One end of the first connecting rod is pivotally connected to the third fixing support, and the other end is pivotally connected to the first driving unit. The second driving assembly has a second driving unit, a second connecting rod and a third connecting rod. One end of the second connecting rod is pivotally connected to the second fixing support, and the other end is pivotally connected to the second driving unit. One end of the third connecting rod is pivotally connected to the second driving unit, and the other end is pivotally connected to the first fixing support.

According to the present invention, the inclination angle of the bed structure can be adjusted more smoothly, so that a user lying thereon can feel more comfortable.

### BRIEF DESCRIPTION OF THE DRAWINGS

FIG. 1 is an exploded perspective view showing a preferred embodiment of the present invention;

FIG. 2 is an assembled perspective view showing the preferred embodiment of the present invention;

FIG. 3 is a schematic view showing the operation of the present invention;

FIG. 4 is a schematic view showing the operation of the present invention; and

FIG. 5 is a schematic view showing the operation of the present invention.

### DETAILED DESCRIPTION OF THE INVENTION

The above objectives and structural and functional features of the present invention will be described in more detail with reference to preferred embodiment thereof shown in the accompanying drawings

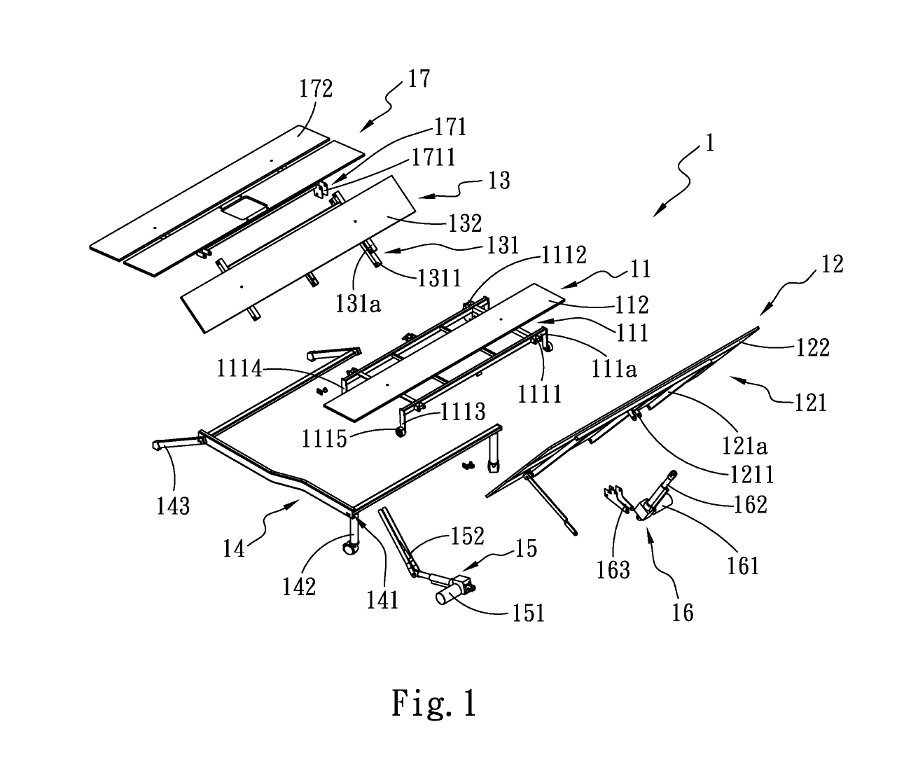

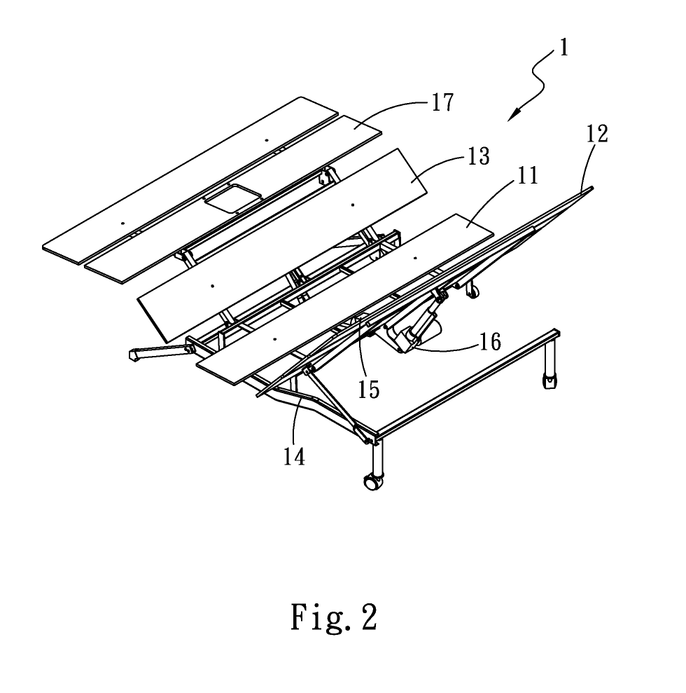

Please refer to FIGS. 1 and 2. FIG. 1 is an exploded perspective view showing a preferred embodiment of the present invention, and FIG. 2 is an assembled perspective view showing the preferred embodiment of the present invention. The present invention provides a bed structure 1 comprising a first body 11, a second body 12, a third body 13, a supporting frame 14, a first driving assembly 15, and a second driving assembly 16.

The first body 11 has a first fixing support 111 and at least one first plate 112. Both sides of the first fixing support 111 extend to form a first connecting end 1111, a second connecting end 1112, a first arm 1113 and a second arm 1114 respectively. The distal ends of the first arm 1113 and the second arm 1114 are provided with at least one sliding element 1115, 1116 respectively.

The first fixing support 111 has a plurality of sub-frames 111a interlinked transversely and longitudinally. The first plate 112 lies flat on the first fixing support 111.

The sliding element 1115, 1116 is a roller.

The second body 12 has a second fixing support 121 and at least one second plate 122. One side of the second fixing support 121 extends to form a third connecting end 1211 pivotally connected to the first connecting end 1111.

The second fixing support 121 has a plurality of sub-frames 121a interlinked transversely and longitudinally. The second plate 122 lies flat on the second fixing support 121.

The third body 13 has a third fixing support 131 and at least one third plate 132. One side of the third fixing support 131 extends to form a fourth connecting end 1311 pivotally connected to the second connecting end 1112.

The third fixing support 131 has a plurality of sub-frames 131a interlinked transversely and longitudinally. The third plate 132 lies flat on the third fixing support 131.

The supporting frame 14 has a guiding rail 141. The sliding element 1115, 1116 is slidingly disposed in the guiding rail 141.

The supporting frame 14 further has a first supporting post 142 and a second supporting post 143.

The first driving assembly 15 has a first driving unit 151 and a first connecting rod 152. One end of the first connecting rod 152 is pivotally connected to the third fixing support 131, and the other end is pivotally connected to the first driving unit 151.

The second driving assembly 16 has a second driving unit 161, a second connecting rod 162 and a third connecting rod 163. One end of the second connecting rod 162 is pivotally connected to the second fixing support 121, and the other end is pivotally connected to the second driving unit 161. One end of the third connecting rod 163 is pivotally connected to the second driving unit 161, and the other end is pivotally connected to the first fixing support 111.

The bed structure 1 further has a fourth body 17. The fourth body 17 has a fourth fixing support 171 and at least one fourth plate 172. One side of the fourth fixing support 171 extends to form a fifth connecting end 1711 pivotally connected to the third fixing support 131.

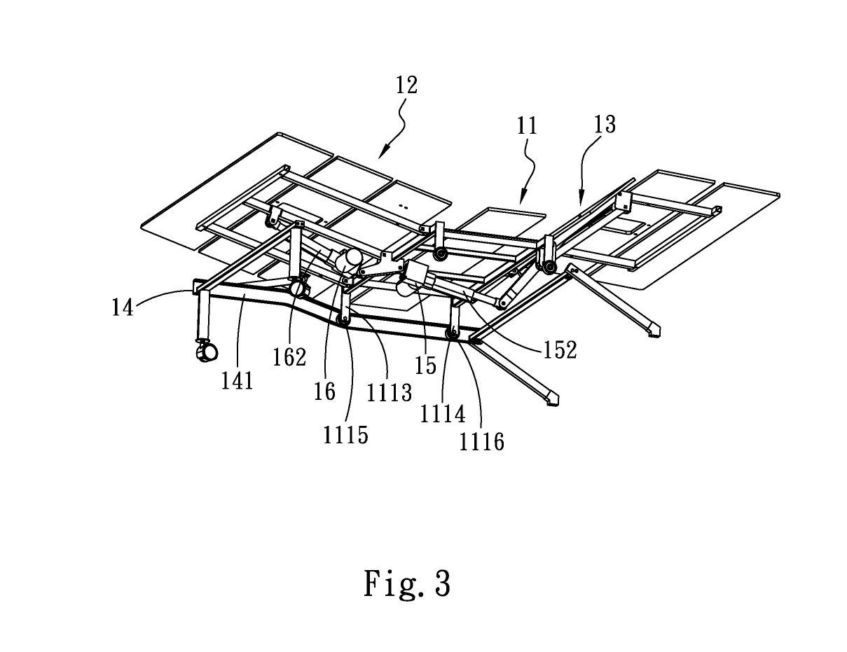

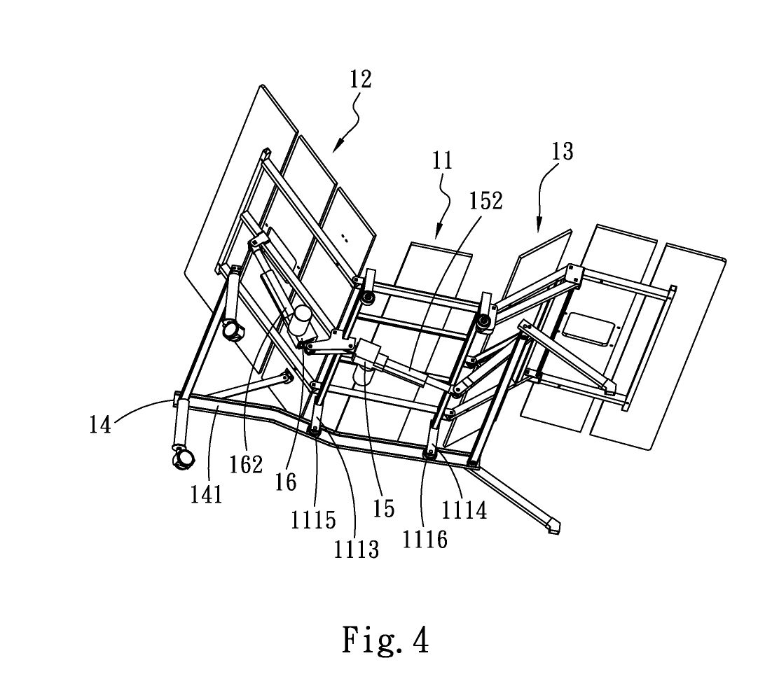

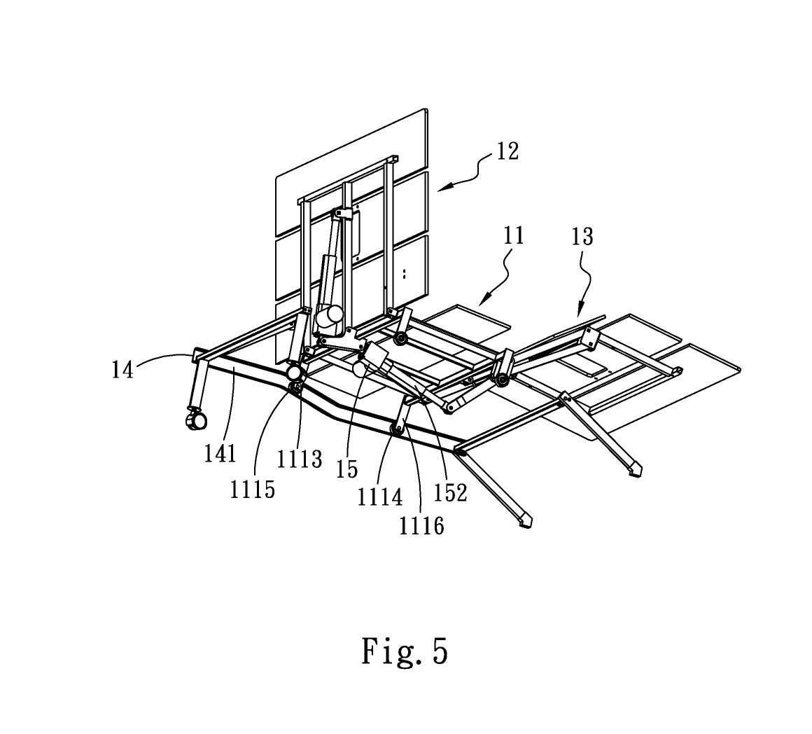

Please refer to FIGS. 3 to 5, which are schematic views showing the operation of the present invention. As shown in these figures, when the first driving assembly 15 drives the first connecting rod 152 to activate, the first connecting rod 152 drives the third body 13 to move, whereby the inclination angle of the third body 13 can be adjusted. When the second driving assembly 16 drives the second connecting rod 162 to activate, the second connecting rod 162 drives the second body 12 to move, whereby the inclination angle of the second body 12 can be adjusted.

When the inclination angles of the third body 13 and the second body 12 are adjusted, the first arm 1113 and the second arm 1114 extending from one side of the first body 11 slide in the guiding rail 141 of the supporting frame 14 by means of the sliding elements 1115 and 1116 provided on the distal ends of the first arm 1113 and the second arm 1114. The first arm 1113 and the second arm 1114 can be driven to ascend or descend when the sliding elements 1115 and 1116 slide in the guiding rail 141. Since the first arm 1113 and the second arm 1114 are formed by extending from the first body 11, the first body 11 will be also driven to ascend or descend accordingly together with the first arm 1113 and the second arm 1114.

By providing the first arm 1113, the second arm 1114, and the sliding elements 1115 and 1116 sliding in the guiding rail 141 of the supporting frame 14, the inclination angles of the first body 11, the second body 12 and the third body 13 can be adjusted more smoothly. Further, the inclination angles of the first body 11, the second body 12, and the third body 13 can be adjusted by means of the first arm 1113, the second arm 1114, and the sliding elements 1115 and 1116 sliding in the guiding rail 141 of the supporting frame 14. Thus, the problem that the degree of freedom in adjusting the inclination angle of the conventional sickbed is limited can be overcome.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A bed structure, including:
a first body, having a first fixing support and at least one first plate, both sides of the first fixing support extending to form a first connecting end, a second connecting end, a first arm and a second arm, distal ends of the first arm and the second arm being provided with at least one sliding element respectively;
a second body, having a second fixing support and at least one second plate, one side of the second fixing support extending to form a third connecting end pivotally connected to the first connecting end;
a third body, having a third fixing support and at least one third plate, one side of the third fixing support extending to form a fourth connecting end pivotally connected to the second connecting end;
a supporting frame, having a guiding rail, the sliding element being slidingly disposed in the guiding rail;
a first driving assembly, having a first driving unit and a first connecting rod, one end of the first connecting rod being pivotally connected to the third fixing support, and the other end being pivotally connected to the first driving unit;
a second driving assembly, having a second driving unit, a second connecting rod and a third connecting rod, one end of the second connecting rod being pivotally connected to the second fixing support, and the other end being pivotally connected to the second driving unit, one end of the third connecting rod being pivotally connected to the second driving unit, and the other end being pivotally connected to the first fixing support.

2. The bed structure according to claim 1, wherein the first fixing support has a plurality of sub-frames interlinked transversely and longitudinally, the first plate lies flat on the first fixing support.

3. The bed structure according to claim 1, wherein the second fixing support has a plurality of sub-frames interlinked transversely and longitudinally, the second plate lies flat on the second fixing support.

4. The bed structure according to claim 1, wherein the third fixing support has a plurality of sub-frames interlinked transversely and longitudinally, the third plate lies flat on the third fixing support.

5. The bed structure according to claim 1, wherein the supporting frame further has a first supporting post and a second supporting post.

6. The bed structure according to claim 1, further including a fourth body, the fourth body having a fourth fixing support and at least one fourth plate, one side of the fourth fixing support extending to form a fifth connecting end pivotally connected to the third fixing support.

7. The bed structure according to claim 1, wherein the sliding element is a roller.
